(19) United States
(12) Patent Application Publication
(10) Pub. No.: US 2014/0274411 A1
(43) Pub. Date: Sep. 18, 2014

(54) Systems And Methods For Making Real-Time Adjustments to Fantasy Sports Leagues

(71) Applicant: T.J. Moffett, Los Angeles, CA (US)

(72) Inventor: T.J. Moffett, Los Angeles, CA (US)

(21) Appl. No.: 14/212,585

(22) Filed: Mar. 14, 2014

Related U.S. Application Data
(60) Provisional application No. 61/786,114, filed on Mar. 14, 2013.

(51) Int. Cl. A63F 13/30

(52) U.S. Cl. CPC A63F 13/12
USPC 463/42

(57) ABSTRACT

Systems and methods for making adjustments and substitutions to a fantasy sports team roster in real-time with the real games played by the real league modeled by the fantasy sports league. The systems and methods include, among other things, computer hardware and software which identifies corresponding points in time during different games as endpoints for calculating and awarding fantasy points for part of a player's performance.

### CROSS REFERENCE TO RELATED APPLICATION(S)

This application claims benefit of U.S. Provisional Patent Application No. 61/786,114, filed Mar. 14, 2013, the entire disclosure of which is incorporated herein by reference.

### BACKGROUND

1. Field of the Invention

This disclosure is related to the field of fantasy sports leagues, specifically to systems and methods for allowing participants in such leagues to make alterations to their fantasy team rosters in real-time.

2. Description of the Related Art

Fantasy sports leagues, sometimes also known as simulated ownership, are enormously popular. Perhaps the most popular fantasy sport is fantasy football, which is uniquely well-suited to fantasy sports play due, among other things, to the structure of the football schedule.

These leagues allow players to simulate the experience of owning or managing a sports team comprised of players in an actual, real-world league. This is generally done on a season by season basis by, prior the beginning of play during a season of an actual sports league, holding a simulated “draft” wherein the fantasy “owners” create fantasy teams with fantasy rosters comprised of real players in the real league. This generally results in any one fantasy team having on its roster players belonging to a plurality of different real-world teams.

As the real players play in real games, they generate sports statistics related to their performance. A system of scoring rules translates these statistics into “points” scored for each owner's fantasy team. For example, in fantasy football, each passing touchdown scored by a real-life quarterback who is on a fantasy owner's fantasy roster may count for 5 fantasy points for that player's fantasy team. As with a real sports league, a fantasy team usually comprises more players than are needed to play the game, with the surplus players playing only when the “starters” are injured and cannot play. Each week, fantasy owners usually select “starters” for various positions from their overall fantasy roster, and these “starters” are the real-world players who will “play” for the fantasy owner's fantasy team that week.

Each owner typically has a limited number of positions for which they can “play” their players each week. For example, an owner may have one excellent quarterback and two mediocre quarterbacks, but only be permitted to “play” or “start” one quarterback each week. Although all three quarterbacks may play in real games, only one is deemed to be “playing” for the fantasy owner. Thus, the fantasy starters for a given fantasy team are essentially a list of which real-world players' statistics in that week's real-world league games will be used to calculate the total fantasy points scored by the fantasy owner's fantasy team. Participating in these leagues generally costs some amount of money, and the fantasy owner with the highest point total each week generally receives a monetary prize, with an eventual overall league champion receiving another, usually larger monetary prize, at the end of the season.

Over the course of the real league season, the real players have ups and downs, good games and bad games, and may be injured. Although owners usually “play” the most talented players on their fantasy rosters to maximize points, an injured player may produce poorer statistics than a less talented but healthy substitute. The fantasy league, thus, simulates the real experience of managing a team in that the fantasy owners must make judgment calls regarding when to play each player. Also, sometimes a real-world player is benched and does not play at all, such as for poor performance or because of injury, and the fantasy owners having that player on their fantasy rosters must select another player to start.

The National Football League is particularly well suited to the fantasy format because of the structure of the NFL season and game week. NFL teams play sixteen regular season games per year, with each team playing at most one game each week. The vast majority of teams play on Sunday, with a few games being held on off days, notably Thursday or Monday night. This results in a predictable football week in which injuries from the previous weekend's play are assessed early during the practice week, and NFL coaches announce how well the players are recovering and which players are expected to play in the coming contest.

This gives fantasy players information in advance of the game which they can use to set rosters for that week. For example, if a fantasy owner learns from a coach that a talented receiver is hobbled by turf toe, the fantasy owner may “bench” that player in favor of a less talented player on his fantasy roster, believing the less talented player will nevertheless play better in the real game (and thus produce more fantasy points) because he is not injured. Alternatively, players may trade players on their rosters.

However, there is a good deal of gamesmanship in real NFL coaching behavior, as coaches routinely oversell or undersell the degree of an injury to keep the team's upcoming opponent guessing as to whether a particular player will play. This forces the opponent to prepare two game plans and makes practice more difficult. However, this gamesmanship also has consequences to fantasy players, who must set their rosters before the game weekend begins. For example, a coach may announce on Wednesday that a given player is not affected by an injury sustained during the previous week of play, but if that player turns out to have been more seriously injured than the coach let on and performs poorly in the coming game, fantasy players who “started” that player may perform poorly in their fantasy leagues that week.

This is because fantasy leagues generally have no way to “bench” a player on the fantasy team in real-time. That is, the fantasy owner does not realize until the real-life games have begun that he has made a mistake, but since he already announced his starters to the league, he cannot go back and change the roster to bench this player. Allowing him to do so would violate the principle that fantasy football should generally simulate team ownership, as the fantasy owner would effectively be able to know in advance how his players would perform and retroactively alter the lineup to avoid underperforming players. This removes much of the skill and unpredictability from fantasy leagues. However, not allowing changes to be made also violates the simulation because a real NFL coach has the ability to bench a player mid-game and substitute in another player who may perform better. By forcing a fantasy owner to be stuck with a player for an entire game, the fantasy owner misses out on the experience of making in-game coaching and lineup decisions, which is a key component of managing a sports team.

Working around this issue is difficult because fantasy teams almost always comprise players on different real-world teams, who may play at different times in different games. For example, a fantasy owner's “backup” player may have already played in an earlier game by the time the owner's starter begins play. Thus, if the owner is allowed to substitute that player for an underperforming starter, the simulation is again violated because the owner knows in advance the performance of the substitute.

Similarly, where players are injured during the real life game and cannot continue to play, fantasy leagues generally have no way to substitute another player for similar reasons. For example, if the starting quarterback receives a concussion and cannot continue the game, the fantasy player gets whatever fantasy points the starter accumulated while playing, but cannot substitute a backup for the remainder of the game.

### SUMMARY

The following is a summary of the invention which should provide to the reader a basic understanding of some aspects of the invention. This summary is not intended to identify critical components of the invention, nor in any way to delineate the scope of the invention. The sole purpose of this summary is to present in simplified language some aspects of the invention as a prelude to the more detailed description presented below.

Because of these and other problems in the art, described herein are systems and methods for allowing real-time adjustments to fantasy sports team rosters in response to events taking place in the real games being played in the league simulated by the fantasy league. Generally, the systems and methods use computer devices and applications to implement fantasy sports roster change rules and record in real-time roster changes made by fantasy owners and to then alter the calculation or tallying of fantasy points scored by each owner. These scoring changes may be based, among other things, upon the specific time that the roster change was made.

Also described herein, among other things, is a system for making automated player substitutions in a fantasy sports team in real-time comprising: a fantasy sports league server communicating over a communication network and comprising a microprocessor and a non-transitory computer-readable storage medium having computer-readable instructions which, when processed by the microprocessor, cause the fantasy sports league server to: accept from a fantasy sports team owner over the communication network data indicative of a fantasy sports team depth chart comprising at least one starting player and at least one substitute player for the starting player; monitor the status and performance of the starting player in a game played by the starting player; monitor the status and performance of the substitute player in a real game played by the substitute player; calculate and award fantasy points to the owner based at least in part upon the performance of the starting player in the real game played by the starting player; calculate and award fantasy points to the owner based at least in part on the performance of the substitute player in the real game played by the substitute player if the server detects that the status of the starting player in the real game played by the starting player changes such that, according to the rules of the fantasy sports team league, the starting player is automatically substituted with the substitute player.

In an embodiment of the system, the change in status of the starting player is selected from the group consisting of injury to the starting player, ejection of the starting player, and benching of the starting player.

In another embodiment of the system, the fantasy points to the owner awarded to the owner based at least in part on the performance of the substitute player are based upon the performance of the substitute player in the real game played by the substitute player after the point in time in the real game played by the substitute player corresponding to the point in time in the real game played by the starting player at which the change in status of the starting player occurred.

In another embodiment of the system, the point in time in the real game played by the substitute player corresponding to the point in time in the real game played by the starting player at which the change in status of the starting player occurred is based at least in part upon the game time indicated by the game clock in the real game played by the substitute player.

In another embodiment of the system, the point in time in the real game played by the substitute player corresponding to the point in time in the real game played by the starting player at which the change in status of the starting player occurred is based at least in part upon the game time indicated by the game clock in the real game played by the starting player.

In another embodiment of the system, the fantasy sports league server accepts the user depth chart data via a website.

In another embodiment of the system, the fantasy sports league server models a professional sports league selected from the group consisting of the National Football League, the National Basketball Association, the National Hockey League, and Major League Baseball.

In another embodiment of the system, the depth chart further comprises a second substitute player for the starting player and the computer-readable instructions, when processed by the microprocessor, further cause the fantasy sports league server to: monitor the status and performance of the second substitute player in a real game played by the second substitute player; calculate and award fantasy points to the owner based at least in part on the performance of the second substitute player in the real game played by the second substitute player if the server detects that the status of the substitute player in the real game played by the substitute player changes such that, according to the rules of the fantasy sports team league, the substitute player is automatically substituted with the second substitute player.

Also described herein, among other things, is a method for making automated player substitutions in a fantasy sports team in real-time comprising: providing a fantasy sports league based at least in part on a real sports league; receiving from a fantasy owner participating in the fantasy sports league an indication of a starting player in the real sports league who will start for the fantasy owner in the fantasy sports league; receiving from the fantasy owner an indication of a substitute player in the real sports league who will substitute for the starting player in the fantasy sports league; monitoring the performance and status of the starting player and the substitute player in real games played by the starting player and the substitute player; awarding fantasy sports league points to the fantasy owner based on statistics indicative of the performance of the starting player in the real game played by the starting players prior to the occurrence in the real game of an automatic substitution event; awarding fantasy sport league points to the fantasy owner based on statistics indicative of the performance of the substitute player in the real game played by the substitute player subsequent to the point in time in the real game played by the substitute player corresponding to the point in time in the real game played by the starting player at which the automatic substitution event occurred.

In an embodiment of the method, the automatic substitution event is selected from the group consisting of injury to the starting player, ejection of the starting player, and benching of the starting player.

In another embodiment of the method, the corresponding point in time is determined based at least in part upon the game time indicated by the game clock in the real world game played by the starting player and the game time indicated by the game clock in the real world game played by the substitute player.

In another embodiment of the method, the fantasy sports league server models a professional sports league.

In another embodiment of the method, the professional sports league is selected from the group consisting of the National Football League, the National Basketball Association, the National Hockey League, and Major League Baseball.

Also described herein, among other things, is a method for making discretionary player substitutions in a fantasy sports team in real time comprising: providing a fantasy sports league server; the server receiving from a fantasy owner participating in the fantasy sports league over a data network an indication of a first player in the real sports league on the fantasy owner's fantasy team in the fantasy sports league; the server receiving from a fantasy owner participating in the fantasy sports league over the data network an indication of a second player in the real sports league on the fantasy owner's fantasy team in the fantasy sports league; the server monitoring the performance of the first player in a first real game played by the first player; the server monitoring the performance of the second player in a first real game played by the second player; the server receiving from the fantasy owner over the data network an indication that the owner desires to substitute the second player for the first player on the fantasy owner's fantasy team; the server identifying the point in time during the first game of the receiving step; awarding fantasy sports league points to the fantasy owner based on statistics indicative of the performance of the first player in the first game during a portion of the first game determined based at least in part on the point in time; awarding fantasy sports league points to the fantasy owner based on statistics indicative of the performance of the second player in the second game during a portion of the second game determined based at least in part on the point in time.

In an embodiment of this method, the fantasy sports league points awarded for the performance of the first player in the first game are determined based upon the performance of the first player in the first game prior to the point in time.

In another embodiment of this method, the point in time is identified based at least in part on the game time indicated by the game clock for the first game.

In another embodiment of this method, the fantasy sports league points awarded for the performance of the second player in the second game are determined based upon the performance of the second player in the second game after a point in time in the second game corresponding to the point in time during the first game of the receiving step.

In another embodiment of this method, the corresponding point in time is based at least in part on the game time indicated by the game clock for the second game.

In another embodiment of this method, the fantasy sports league server models a professional sports league.

In another embodiment of this method, the professional sports league is selected from the group consisting of the National Football League, the National Basketball Association, the National Hockey League, and Major League Baseball.

### BRIEF DESCRIPTION OF THE DRAWINGS

FIG. 1 depicts a schematic diagram of an embodiment of the systems and methods.

FIG. 2 depicts a mock-up of one user interface screen in an embodiment of an application.

### DESCRIPTION OF THE PREFERRED EMBODIMENT(S)

The following detailed description and disclosure illustrates by way of example and not by way of limitation. This description will clearly enable one skilled in the art to make and use the disclosed systems and apparatus, and describes several embodiments, adaptations, variations, alternatives and uses of the disclosed systems and apparatus. As various changes could be made in the above constructions without departing from the scope of the disclosures, it is intended that all matter contained in the above description or shown in the accompanying drawings shall be interpreted as illustrative and not in a limiting sense.

Described herein are systems and methods for allowing real-time adjustments to fantasy sports team rosters in response to events taking place in the real games being played in the league simulated by the fantasy league. Generally, the systems and methods use computer devices and applications to implement fantasy sports roster change rules and record in real-time roster changes made by fantasy owners and to then alter the calculation or tallying of fantasy points scored by each owner. These scoring changes may be based, among other things, upon the specific time that the roster change was made.

A feature of the systems and methods is that they take advantage of the fast response time of computer systems to allow fantasy players to respond in real-time or near real-time to actual game conditions on game day. That is, players using the systems and methods may cause fantasy roster changes to be made in direct response to events transpiring in real time or near real-time on the playing field.

FIG. 1 depicts a high-level diagram of an embodiment of the systems and methods. A fantasy owner (101) participating in a fantasy sports league drafts players and sets a roster of starters in advance of one or more real games to be played in the real league simulated by the fantasy league. By way of example and not limitation, this league may be the National Football League (NFL), National Basketball Association (NBA), National Hockey League (NHL), Major League Baseball (MLB), or any other league, whether professional or amateur. When one or more of the real games (111) are underway, the fantasy owner (101) monitors (102) one or more of those games (111), including without limitation player injuries and statistical performance of players. The owner (101) may watch the games on a television, listen to a radio broadcast, follow games using a computer, or use any other method known in the art.

In response to an event taking place in one or more real games (111), the owner (101) may determine that he wishes to make a fantasy roster change, for example, “benching” a starter in favor of another player on the owner's (101) fantasy roster. This generally means the owner (101) will no longer accumulate fantasy points for any further statistics accumulated by the “benched” player in the real game (111), whether or not the real player actually leaves the real game (111). Instead, the owner (101) will begin to accumulate fantasy points from statistics accumulated by the substituted player in the real game in which the substitute player is playing.

The owner (101) generally executes this decision by indicating the player to be benched and the player to be substituted in a user interface of a computer application (104). The benched player, substituted player, and the time when this roster change was entered by the owner (101) are generally recorded by the application and transmitted over a data network (109) to a fantasy sports league server system (105). The server system (105) generally implements a fantasy sports league rules, features, functions, and calculations, and may also provide data stream services and/or a user interface through which fantasy owners may view and manage their fantasy teams. The server system (105) generally includes a database (107) and includes or has access to real-time performance statistics of players in the real-life league simulated by the fantasy league.

Data relating to the decision of the fantasy owner (101) to make a roster change is generally recorded by the server system (105), such as in the database (107), and that data is included in the method for calculating the fantasy owner's (101) point total for the week. Capturing the time that the owner (101) made the roster change is sometimes needed in an embodiment to determine the game clock time at which a player was “benched” or “substituted” by the owner (101), as described in more detail elsewhere herein. Accurately tracking when roster changes are made by the owners (101) also inhibits gaming or abusing of the fantasy league scoring system or roster change rules, such as by taking advantage of hindsight knowledge to time a roster change.

While it is generally expected that players (101) will utilize the application (104) on a mobile device (103) such as a smart phone or tablet PC, it is specifically contemplated that any device may be used to register the roster change. For example, a desktop PC or laptop may be used, including without limitation through a standalone application or web site interface. The device (103) generally transmits the roster change data to a server system (105) using a data network (109), generally the Internet. However, it is also specifically contemplated that the data may be stored or used locally on the device (103). For example, if a network (109) connection is not available, the device (103) may cache the roster change data locally and transmit it later once a network (109) connection is established.

Several embodiments are specifically contemplated for implementing roster changes in real-time. In one such embodiment, a fantasy depth chart allows for automatic promotions of backup players to starter positions if a starter is removed from the real game. Prior to the commencement of real league play, a fantasy owner (101) uses the application (104) to configure a depth chart for his fantasy team for that week of play. The depth chart is essentially a list of players and substitution priorities at each position, similar to a real sports team depth chart. The depth chart usually includes a “starter” and one or more “backups” listed in order of priority.

The application (104) transfers this data to the server system (105), which then stores the owner's (101) depth chart for that week in a database (107). When league play begins, generally, the server system (105) monitors a data feed or source providing real-time or near real-time data concerning events taking place in the real league games which may trigger an automatic promotion on a fantasy owner's (101) roster as provided in the depth chart. These events include injuries, ejections, benchings, and other in-game events which may necessitate an automatic promotion. In an alternative embodiment, the server (105) monitoring is supplemented, augmented, or replaced by a staff of one or more people who perform similar monitoring.

When such an event is detected, the server system (105) consults depth charts in the database (107) to determine whether any automatic substitution must be made. If, for example, a player has been injured and removed from the real game, the server system (105) will determine whether any owners (101) have depth charts for that week starting the injured player. If so, for each such owner (101), the server (105) will promote the first substitute listed on the depth chart for each such owner (101). This automatic promotion is generally done in real-time in response to the event, and the updated roster may be transmitted by the server (105) to the owner's (101) device (103), and the change may be indicated in the application (104). Other forms of conveying this automatic promotion may also be used, such as texting, emailing, or otherwise alerting the owner (101), among other things, that an automatic roster promotion has been made, which player was removed, and which player was substituted.

This substitution is done automatically and in accordance with the depth chart provided by the owner (101) in advance. This requires the owner (101) to decide in advance who will substitute for an injured starter, and this decision generally cannot be changed later.

By way of example and not limitation, an owner (101) configures a depth chart in the application (104) by, among other things, designating the real-life player QB1 as his starter at quarterback with QB2 and QB3 as the backups in that priority order. If QB1 is injured during the course of the game he is playing, in the prior art the fantasy owner (101) would receive little or no fantasy points at the quarterback position for that week because QB1 will generate no further statistics in the game. Using the depth chart systems and methods described herein, the server system (105) would automatically promote QB2 as provided by the owner's (101) depth chart configuration submitted in advance of the commencement of real play, and the owner (101) would receive further fantasy points for that week based on statistics generated by QB2 in the game in which QB2 played.

It will often happen that the substituted player has already completed his game when the starter is injured. In that situation, the owner (101) knows what statistics QB2 compiled during his game, but because the depth chart promotions are generally automatic and generally not discretionary, the owner (101) cannot take advantage of this knowledge to game the system. The promotion is made automatically only if QB1 is removed from the game for a reason that, under the fantasy league rules, allows a substitution. For example, where the league is basketball and the starting player fouls out, fantasy league rules may not permit a substitution.

The “automatic substitution” includes a modification to the method for calculating the fantasy points scored by the owner (101), and may also effect other elements of the systems and methods. By way of example and not limitation, the server system (105) may not monitor statistics or events pertaining to real players who are not “starting” for any owner (101) in the fantasy league. If an automatic promotion is made, the server system (105) may begin to monitor such statistics or events. Automatic promotions may also result in the server (105) sending updated data to the owner (101) or other participants in the fantasy league informing them, among other things, of the roster change.

One problem with such a substitution is that it may unfairly bias the owner's (101) point total upward. To mitigate this issue, special rulesets, systems, methods, or other mechanics may be utilized, including but not limited to partial performance totals, wholesale substitution, and weighted average. Each of these are described in further detail herein.

The fantasy point calculation method may use partial performances of players. This technique is perhaps best understood through an example. Continuing with the example described above, if QB1 is injured at the 10:23 mark of the second quarter of his game and had to that point accumulated two touchdowns and 206 yards of passing offense, those statistics would be used by the systems and methods as at least part of the fantasy point total tallied for the owner (101) who started QB1 for his fantasy team. However, at least part of the statistics generated by QB2 would also be used by the systems and methods as at least part of the fantasy point total tallied for the owner (101) because QB2 was automatically substituted for QB1 in response to QB1's injury in this example. This more closely provides the owner (101) with the real-life experience of managing a team.

Continuing with this example, the statistics accumulated by QB1 through the point in QB1's game (referred to for simplicity as “Game 1”) at which QB1 was injured may be used to determine a partial point total at the QB position for fantasy players playing QB1. In a league, for example, where touchdowns are worth 5 points, and every 100 passing yards are worth 5 points, QB1 in this example produces 20 points.

However, the owner (101) is not, in this example, entitled to receive fantasy points for the entire performance of QB2 in QB2's game (referred to for simplicity as “Game 2”) because doing so would effectively give the fantasy owner (101) points for more than a single game worth of quarterback play, biasing his score upward and potentially providing a windfall. That is, the fantasy owner (101) should not receive both the statistics compiled by QB2 during the 60:00 of Game 2 and the statistics compiled by QB1 during the 19 minutes and 37 seconds of Game 1 in which QB1 played before he was injured.

To blend these two sets of statistics, the systems and methods use the statistics accumulated by QB1 during the 19:37 of Game 1 in which he played to calculate a partial fantasy point total for the owner (101) at the quarterback position, and use the statistics accumulated by QB2 during the portion of Game 2 corresponding to the period of Game 1 during which QB1 was not playing. In the present example, this corresponds to the statistics compiled by QB2 from the 10:23 mark of Game 2 through the end of Game 2, which would be used to calculate the owner's (101) fantasy point total at quarterback.

Thus, if QB2 threw for 3 touchdowns, one of which was scored during the first quarter of Game 2, this portion of Game 2 corresponds to the portion of Game 1 when QB1 was still playing (e.g., prior to the 10:23 mark of the second quarter), and thus even though QB2 was also playing in the real Game 2, only QB1 was “playing” at that time for the fantasy owner (101). As such, QB1's statistics in Game 1 are used for that time period of Game 1, and the touchdown scored by QB2 during that corresponding time period of Game 2 is disregarded for purposes of the owner's (101) fantasy point total. This effectively gives the fantasy player (101) a full 60:00 minutes worth of game time during which his starters and backups can accumulate statistics, and no more.

This technique has a number of advantages. In addition to avoiding biasing an owner's (101) points by awarding more than 60:00 minutes worth of statistics, it provides a mechanism for splicing together two separate games. In the above example, Game 2 might be played before Game 1, such as on Thursday night, whereas Game 1 is played the following Monday. When QB1 is injured and cannot play the remainder of Game 1, the quarterbacking statistics which will be used to calculate the fantasy points for the owner (101) at the quarterbacking for the remainder of the football weekend are already known because, as provided by the player (101) in his depth chart, QB2 is automatically promoted to replace QB1, and QB2's game has already been played in its entirety. Conversely, if QB2 has not played Game 2 yet, the fantasy owner (101) must wait until the 10:23 mark of the second quarter of Game 2 to determine what quarterbacking statistics will be used for the rest of the owner's (101) quarterbacking fantasy points for that week.

The systems and methods provide, among other things, for including in the calculation of a score only a part of the statistics accumulated by a player in a sporting event, wherein the part of the statistics of that player which will be included in the calculation of the score is determined based on when during the sporting event the player accumulated the statistics and also based on when during a different sporting event an event in that different sporting event took place.

In an alternative embodiment, the statistics of the substituted player are substituted for those of the injured player en tow. For example, it may be difficult or impossible, in some leagues, to acquire sufficiently granular statistics to implement this system. By way of example and not limitation, while the point of time during a football game at which a touchdown was scored is generally available, it may be more difficult to temporally divide other statistics. In such an embodiment, when a starter is injured, the automatic promotion of the substitute means the server system (105) will disregard the starter's performance entirely and use only the performance of a backup when calculating fantasy points for the owner (101). Thus, in the above example, the 2 touchdowns and 206 yards accumulated by QB 1 would not be counted at all towards the owner's (101) total, but all three of the touchdowns scored by QB2 would be counted.

The fantasy owner (101) may also use the systems and methods to order a fantasy roster substitution in real-time based upon performance of players on the owner's (101) fantasy teams in real games as those games are taking place. A key element of managing a sports team is adjusting players and strategy in response to game conditions and player performance, and the systems and methods incorporate this element into the fantasy league experience. For example, a player starting for the fantasy owner (101) may have a particularly bad matchup in a game, and may be performing poorly, whereas a player on the fantasy owner's (101) “bench” (i.e., although the real player is playing in a real game, he is not “playing” for the fantasy team and thus his performance is not included in determining the fantasy owner's (101) fantasy points) may be having an excellent game.

Roster changes are generally similar to automatic promotions with a few notable differences, primarily that roster changes are generally discretionary by owner (101), meaning the owner (101) may make such a substitution or not, depending upon his subjective assessment of which player on his fantasy team is likely to produce the most fantasy points for the owner (101). By contrast, a depth chart substitution is carried out automatically in response to events beyond the fantasy player's (101) control.

Generally, in the preferred embodiment, it is contemplated that a roster change may be made at the half-time of the game in which the player to be benched is playing. Although the roster change may be entered into the application (104) by the owner (101) prior to that point, it does not become effective until half-time, meaning the first half performance of the “benched” player still is included in the owner's (101) fantasy point calculation for that player's position. It is also generally contemplated that roster changes are one-directional, meaning that, if the substituted player also performs badly, the owner (101) may not “bench” him and revert to his starter.

However, in an alternative embodiment, roster changes may be made in real time at any point during the real game in which the player to be benched is playing. In such an embodiment, the partial performance scoring rules described elsewhere herein may be used to determine which portion of the “benched” player's performance is included in the owner's (101) point total, and which portion of the substituted player's performance is included in the owner's (101) point total.

One difficulty with a roster change is that, unlike an automatic promotion, there is generally no actual event taking place during the game which causes the “benched” player to leave the game and stop generating statistics. Normally, the player is only “benched” from the fantasy team, not the real team, and the player continues to play in the real game. A mechanism is needed for establishing the point during the real game at which the fantasy owner (101) “benched” the player, and the corresponding point in the real game in which the substitute player is playing that the fantasy owner (101) “played” that player.

Generally, this is handled by the application (104) recording the date and time, including time zone, when the owner (101) entered into the application (104) his decision to bench the player. When the owner (101) uses the user interface to input the benching decision, the application (104), as part of that processing, records the time, capturing the real-time that the instruction was entered. Because most mobile devices receive and update their internal clocks using a network time protocol or service, the time recorded by the mobile device is generally very accurate to within a few seconds, and the time recorded for the owner's (101) benching decision is thus very accurate.

This time, along with other data, including but not limited to the player to be benched and the player to be substituted, is sent by the mobile device (103) to the server system (105) over the network (109). The server system (105) then uses the benching decision time to determine the amount of time on the game clock in the real game at the moment that the benching decision was inputted into the application (104) by the owner (101). This becomes the “substitution time” used to perform the partial performance calculations described elsewhere herein. This process is generally conducted in real-time so that the game clock time is accurately preserved for purposes of the fantasy point calculation. This process may also require that the decision times be converted from its local time to the local time of the game in which the benched player is playing.

An example may clarify. By way of example and not limitation, a fantasy owner (101) starts QB1 in Game 1, which kicks off at 12:00 pm, but QB1 plays poorly. At the 12:19:58 pm the owner (101) inputs into the application (104) that he is benching QB1 in favor of QB2, who plays in Game 2 later that evening. The application (104) notes the current time—12:19:58 pm—and immediately transmits the roster change data to the server system (105). Upon receiving this data, the server system (105) examines the roster change data to determine which player is being benched and in which game that player is playing. The server system (105) then determines the status of the game clock in that game, including the quarter and amount of time remaining, and records that status in the database (107). In this example, the server system (105) determines that there are 10:00 minutes remaining in the first quarter of Game 1, and the server system (105) records or stores that data in a database (107) in connection with the owner's (101) benching decision. The system (105) then discontinues monitoring the performance of QB1 with regard to that owner (101). When QB2 begins Game 2 later that evening, the server system (105) will monitor QB2's performance from the 10:00 minute mark of the first quarter of Game 2 onward with regard to that owner (101). However, the owner (101) does not receive any fantasy points for the performance of QB2 prior to the 10:00 mark of the first quarter of Game 2, because the player (101) had not yet “benched” QB1 and QB2 was not yet “playing” for the fantasy player (101).

To prevent abuse, an owner (101) generally may not bench a starter in favor of a substitute who has already played. This violates the simulation in that it allows players to make roster decisions based on, effectively, advance knowledge of player performance. Returning to the above continuing example, if the owner's (101) backup quarterback had already played when the owner's (101) starter began his game, the application (104) would not transmit the roster change request to server system (105) or, alternatively, the server system would refuse or disregard any such request, responding to the application (104) with an error. However, if the owner (101) has another player for that position who has not yet played, such as QB3, the owner (101) may be permitted to bench QB1 in favor of that player, i.e., QB3.

In an alternative embodiment, an owner (101) may make a discretionary substitution even if the player to be substituted has already begun his game. Continuing the above examples, if QB1 and QB2 are both playing in games which kicked off at about the same time, the owner (101) may in some circumstances be able to bench QB1 in favor of QB2 because QB2's performance for the remainder of his game is not yet known. Although it generally is the case that the game clocks in two games that kick off at the same time do not stay synchronized, where the game clock in QB2's game is behind the game clock in QB1's game, QB1 may be benched in favor of QB2 without violating the simulation. For example, if the third quarter has concluded in QB1's game, but there are 4:00 remaining in the third quarter of QB2's game, the application (104) may allow the player (101) to enter a roster change benching QB1 in favor of QB2.

Discretionary benching does present some issues whereby an owner (101) can game the system. For example, if QB1's team is winning by three touchdowns going into the fourth quarter, the owner (101) reasonably anticipates that QB1 will not attempt many passes, nor will any passing touchdowns likely be scored by him. Conversely, if QB2's team is losing in the fourth quarter, the owner (101) reasonably anticipates that QB2 will be making more passing attempts and is more likely to score a passing touchdown. The owner (101) thus benefits by benching QB1 in favor of QB2 to maximize his fantasy points, even though QB1's performance has been adequate. To mitigate this gamesmanship, fantasy points may be calculated differently for a discretionary benching, generally by weighting the amount of points awarded to the owner (101) by the proportion of each player's respective game in which the player “played” for the owner (101).

In the above example, where QB1 is benched in the third quarter, the owner (101) receives only ¾ths of the fantasy points earned by QB1 during the game, even if all of the fantasy points earned by QB1 were earned before QB1 was “benched” by the owner (101). Similarly, the owner (101) receives only ¼^{th} of the fantasy points earned by QB2 in his game, even if all of the fantasy points earned by QB2 were earned after he was substituted for QB1 by the owner (101). This weighted average discourages owners (101) from trying to game the system and helps to preserve the simulation.

In a still further embodiment, substitutions may be made whereby a player is benched at one position in favor of a player who plays a different position. For example, owners (101) may have some flexibility in how many players the owner (101) starts at each position. Some football schemes, for example, use three wide receivers and two halfbacks, while others use five receivers and no halfbacks. The systems and methods may allow a player to use the application (104) to alter the fantasy roster in real-time by benching a player at one position in favor of a player at another position. For example, the owner (101) may have started four wide receivers and one running back only to discover that his wide receivers are playing in games experiencing bad weather and there is little passing. The owner (101) may alter his formation, such as by switching from a 4/1 to a 3/2, to bring a second running back into his fantasy roster for the weekend, while benching an underperforming receiver. The fantasy point scoring systems and methods described elsewhere herein may also be used in conjunction with this kind of substitution.

The application (104) may convey to the owner (101) an indication of the owner's (101) point total calculation in these and other contexts. For example, FIG. 2 depicts a mock-up of a graphical user interface showing the temporal division of points between an owner's (101) starting player (here, “A. Smith”) and the owner's (101) backup (here, “J. Brown”) when the starter is injured. The interface contains a header portion identifying the owner, week of play, position, and depth chart settings for the position (200), as well as a visual depiction of the temporal division of the sporting event—here the four quarters of an NFL game (202). The interface displays for each player in the roster who “played” for the owner that week a timeline (204) and (206) showing what portion of the total game time was “played” by that player for the owner (101).

In the depicted embodiment of FIG. 2, the starter's timeline (204) reflects that the player played a partial game, and includes a further indication (208) that the player left the game at the 10:23 mark due to an injury. The indication (208) for the starter also, in the depicted embodiment, conveys statistics accumulated by the player up to that point—here, two touchdowns and 206 yards of passing offense. The interface further includes a second timeline (206) for the player automatically promoted to the quarterback position as provided by the owner's (101) depth chart settings (200), and a second indication (210) explaining which player was substituted, and in which real game that player played or will play. In the depicted embodiment, the substitute already completed his game and the second indication (210) includes the final score of that game. Because the game has concluded, the remaining fantasy points that this owner (101) will receive at the quarterback position for this week can be determined, and the statistics compiled by the substitute in the real game in which he played, from the 10:23 mark of that game until its conclusion, are used to complete the indication (210) of the scoring in the interface. An indication (212) of the game statistics accumulated by each player and included in the fantasy point calculation is also provided, as is an indication (214) of the overall fantasy points earned by the owner (101) for this week at this position.

The application (104) may display the currently active rosters of some or all members of the fantasy league in real-time, including roster changes resulting from automatic promotions, allowing each owner (101) to see which of his starters are no longer playing, and which substitutions have been automatically promoted to play. This not only helps the owner (101) keep track of his fantasy team, but to assess the performance of the substitute, who might still be benched in favor of yet another player, as elsewhere described herein.

The fantasy scoring system may also include player performance statistics in a specified context. For example, the point scoring may identify certain “impact” players during the game and award points for such players, even if the play would not otherwise normally yield fantasy points. By way of example and not limitation, where a defensive player causes a turnover during a final drive, effectively sealing the victory, the play may be worth additional points. Similarly, in another embodiment, other “game-changing” players may receive special treatment in the scoring methodology, including without limitation, turnovers, field position plays such as long non-touchdown punt and kickoff returns, punts downed near the end zone, blocked kicks, onside kicks, muffed punts, and trick plays and fakes.

Although this disclosure is described generally with respect to fantasy football, it is specifically contemplated that the systems and methods described herein may apply any form of simulated ownership, including but not limited to sports leagues and other competitive leagues.

While this invention has been disclosed in connection with certain preferred embodiments, this should not be taken as a limitation to all of the provided details. Modifications and variations of the described embodiments may be made without departing from the spirit and scope of this invention, and other embodiments should be understood to be encompassed in the present disclosure as would be understood by those of ordinary skill in the art.

1. A system for making automated player substitutions in a fantasy sports team in real-time comprising:
a fantasy sports league server communicating over a communication network and comprising a microprocessor and a non-transitory computer-readable storage medium having computer-readable instructions which, when processed by said microprocessor, cause said fantasy sports league server to:
accept from a fantasy sports team owner over said communication network data indicative of a fantasy sports team depth chart comprising at least one starting player and at least one substitute player for said starting player;
monitor the status and performance of said starting player in a game played by said starting player;
monitor the status and performance of said substitute player in a real game played by said substitute player;
calculate and award fantasy points to said owner based at least in part upon the performance of said starting player in said real game played by said starting player;
calculate and award fantasy points to said owner based at least in part on the performance of said substitute player in said real game played by said substitute player if said server detects that said status of said starting player in said real game played by said starting player changes such that, according to the rules of the fantasy sports team league, said starting player is automatically substituted with said substitute player.

2. The system of claim 1, wherein said change in status of said starting player is selected from the group consisting of injury to said starting player, ejection of said starting player, and benching of said starting player.

3. The system of claim 1, wherein said fantasy points to said owner awarded to said owner based at least in part on the performance of said substitute player are based upon the performance of said substitute player in said real game played by said substitute player after the point in time in said real game played by said substitute player corresponding to the point in time in said real game played by said starting player at which said change in status of said starting player occurred.

4. The system of claim 3, wherein said point in time in said real game played by said substitute player corresponding to the point in time in said real game played by said starting player at which said change in status of said starting player occurred is based at least in part upon the game time indicated by the game clock in said real game played by said substitute player.

5. The system of claim 3, wherein said point in time in said real game played by said substitute player corresponding to the point in time in said real game played by said starting player at which said change in status of said starting player occurred is based at least in part upon the game time indicated by the game clock in said real game played by said starting player.

6. The system of claim 1, wherein said fantasy sports league server accepts said user depth chart data via a website.

7. The system of claim 1, wherein said fantasy sports league server models a professional sports league selected from the group consisting of the National Football League, the National Basketball Association, the National Hockey League, and Major League Baseball.

8. The system of claim 1, wherein said depth chart further comprises a second substitute player for said starting player and said computer-readable instructions, when processed by said microprocessor, further cause said fantasy sports league server to:
monitor the status and performance of said second substitute player in a real game played by said second substitute player;
calculate and award fantasy points to said owner based at least in part on the performance of said second substitute player in said real game played by said second substitute player if said server detects that said status of said substitute player in said real game played by said substitute player changes such that, according to the rules of the fantasy sports team league, said substitute player is automatically substituted with said second substitute player.

9. A method for making automated player substitutions in a fantasy sports team in real-time comprising:
providing a fantasy sports league based at least in part on a real sports league;
receiving from a fantasy owner participating in said fantasy sports league an indication of a starting player in said real sports league who will start for said fantasy owner in said fantasy sports league;
receiving from said fantasy owner an indication of a substitute player in said real sports league who will substitute for said starting player in said fantasy sports league;
monitoring the performance and status of said starting player and said substitute player in real games played by said starting player and said substitute player;
awarding fantasy sports league points to said fantasy owner based on statistics indicative of the performance of said starting player in said real game played by said starting player prior to the occurrence in said real game of an automatic substitution event;
awarding fantasy sport league points to said fantasy owner based on statistics indicative of the performance of said substitute player in said real game played by said substitute player subsequent to the point in time in said real game played by said substitute player corresponding to the point in time in said real game played by said starting player at which said automatic substitution event occurred.

10. The method of claim 9, wherein said automatic substitution event is selected from the group consisting of injury to said starting player, ejection of said starting player, and benching of said starting player.

11. The method of claim 9, wherein said corresponding point in time is determined based at least in part upon the game time indicated by the game clock in said real world game played by said starting player and the game time indicated by the game clock in said real world game played by said substitute player.

12. The method of claim 9, wherein said fantasy sports league server models a professional sports league.

13. The method of claim 12, wherein said professional sports league is selected from the group consisting of the National Football League, the National Basketball Association, the National Hockey League, and Major League Baseball.

14. A method for making discretionary player substitutions in a fantasy sports team in real time comprising:
providing a fantasy sports league server;
said server receiving from a fantasy owner participating in said fantasy sports league over a data network an indication of a first player in said real sports league on said fantasy owner's fantasy team in said fantasy sports league;
said server receiving from a fantasy owner participating in said fantasy sports league over said data network an indication of a second player in said real sports league on said fantasy owner's fantasy team in said fantasy sports league;
said server monitoring the performance of said first player in a first real game played by said first player;
said server monitoring the performance of said second player in a first real game played by said second player;
said server receiving from said fantasy owner over said data network an indication that said owner desires to substitute said second player for said first player on said fantasy owner's fantasy team;
said server identifying the point in time during said first game of said receiving step;
awarding fantasy sports league points to said fantasy owner based on statistics indicative of the performance of said first player in said first game during a portion of said first game determined based at least in part on said point in time;
awarding fantasy sports league points to said fantasy owner based on statistics indicative of the performance of said second player in said second game during a portion of said second game determined based at least in part on said point in time.

15. The method of claim 14, wherein said fantasy sports league points awarded for the performance of said first player in said first game are determined based upon the performance of said first player in said first game prior to said point in time.

16. The method of claim 14, wherein said point in time is identified based at least in part on the game time indicated by the game clock for said first game.

17. The method of claim 14, wherein said fantasy sports league points awarded for the performance of said second player in said second game are determined based upon the performance of said second player in said second game after a point in time in said second game corresponding to said point in time during said first game of said receiving step.

18. The method of claim 17, wherein said corresponding point in time is based at least in part on the game time indicated by the game clock for said second game.

19. The method of claim 14, wherein said fantasy sports league server models a professional sports league.

20. The method of claim 19, wherein said professional sports league is selected from the group consisting of the National Football League, the National Basketball Association, the National Hockey League, and Major League Baseball.
